(19) United States
(12) Patent Application Publication
(10) Pub. No.: US 2021/0227837 A1
(43) Pub. Date: Jul. 29, 2021

(54) NATAMYCIN FOR THE PRESERVATION OF A BAKED PRODUCT

(71) Applicant: DSM IP ASSETS B.V., Heerlen (NL)

(72) Inventor: Ben Rudolf DE HAAN, Echt (NL)

(21) Appl. No.: 16/967,661

(22) PCT Filed: Feb. 7, 2019
(86) PCT No.: PCT/EP2019/052959

§ 371 Date: Aug. 5, 2020

(30) Foreign Application Priority Data
Feb. 8, 2018 (EP) 18155719.0
Oct. 22, 2018 (EP) 18201712.9

(51) Int. Cl. A21D 15/08; A23L 3/3463; A23L 3/3517; A23L 3/349; A01N 43/90

(52) U.S. Cl. CPC A21D 15/08; A23L 3/34635; A23V 2002/00; A23L 3/349; A01N 43/90; A23L 3/3517

(57) ABSTRACT

This invention relates to a process for improving the shelf life of a baked product by applying natamycin on the outer surface.

### FIELD

This invention relates to a process for improving the shelf life of a baked product by applying natamycin on the outer surface.

### BACKGROUND OF THE INVENTION

Baked products typically emerge from the baking process with a sterile surface. However, post bake handling can quickly lead to fungal surface contamination through exposure to air borne contaminants as well as equipment contact. Baked products with a relatively neutral pH, high moisture content and high water-activity such as bread, cakes, muffins, waffles, and tortillas are particularly prone to rapid spoilage from a variety of molds, like Aspergillus and Penicillium species. The manufacture of good tasting, high moisture baked products that have a long mold-free shelf life is an ongoing challenge.

Various methods are known to improve shelf life of food products such as baked products. These include addition of humectants to reduce the water activity, addition of chemical mould inhibiting preservatives such as propionates or sorbates into the products, limitation of the availability of oxygen via modified atmosphere packaging or inclusion of oxygen scavengers. Chemical preservatives such as sorbate and propionate have the best effect at low pH, so acids are often added in combination with these preservatives to reduce the pH of the bakery product and hence improve the effectiveness of the added preservative. However, acids, chemical preservatives and humectants can affect the flavor and quality of the product and their use is often a compromise between achieving the best tasting product and the longest possible shelf life. Moreover, the use of chemical preservatives is becoming increasingly problematic as many are not considered green label (green label referring to products being less damaging to the environment compared to similar products).

For many decades, the polyene macrolide antimycotic natamycin has been used to prevent fungal growth on food products, initially products such as cheeses and sausages and later also beverages, crop, and fruit. This natural preservative, which is produced by fermentation using Streptomyces natalensis, is widely used as a food preservative and has a long history of safe use. Despite its long-term use, the development of strains that are resistant to natamycin has hitherto not been reported. Natamycin has not been reported to have any adverse quality or flavor impact on food products.

The use of natamycin for the preservation of a baked product has been described. EP 1382261 discloses application of microbial inhibitors, of which natamycin can be an example, in the production of baked products, however the microbial inhibitor is added to the dough and not applied post-baking, resulting in only a fraction of the preservative exerting its activity on the sensitive surface.

Most often, natamycin is applied in the form of an aqueous suspension wherein, at a pH value usually close to neutral, the compound is only sparingly soluble with a maximum solubility around 40 ppm. The compound is active over a wide pH range and unlike many organic acid preservatives it is not dependent on a low pH acidic environment to show good anti-fungal activity. Natamycin is most stable at neutral pH (J. Stark and H. S. Tan (2003) ‘Natamycin’; in: Food Preservatives, Second Edition. Eds.: N. J. Russell and G. W. Gould. Kluwer Academic/Plenum Publishers). In practice, when such suspensions are applied to food stuffs such as cheese or sausages, the natamycin will mainly be present in the form of crystals on the surface of the product where only the dissolved fraction of natamycin is active.

Because natamycin is sparingly soluble in aqueous liquids, with its maximum solubility around 40 ppm, conventional application methods still have many drawbacks. These drawbacks include the plugging of nozzles during application of the natamycin solution or suspension and the need of constant agitation. These drawbacks contribute to considerable problems with inconsistency in application. The tendency of undissolved crystals to settle at the bottom of treatment or storage vessels is referred to as physical instability of the suspensions. To circumvent this problem frequent mixing of the suspension and/or recirculation of the treatment liquid is required. Another approach is modification of the morphology such as for example the development of needle shaped crystals of natamycin that display significantly prolonged sedimentation times, as reported in WO 2006/045831. Also, the precipitation of natamycin particles on a surface causes the formation of a white haze resulting from application of commercially available natamycin suspensions. This is particularly problematic in the application of natamycin on food surfaces that become less attractive as a result of hazing, such as various bread applications. In WO 2007/051813 physical instability is addressed by the formation of essentially non-aqueous solutions of natamycin in mixtures of polyhydric and monohydric alcohols. Although relatively high concentrations of natamycin are obtained, unfortunately only physical stability was determined, and no information or suggestion is given in relation to chemical stability, i.e. the degree to which the natamycin molecule remains intact.

Many bakery products are required to have a long shelf life, e.g. up to 2 to 10 weeks and sometimes longer at ambient temperature. The high water-content of many bakery products makes them sensitive to spoilage due to mould and yeast growth, a problem that may be solved by the application of known natamycin-containing suspensions. For example, WO 2005/074690 discloses a non-yeast-leavened baked product, the outer surface of which has natamycin deposited thereon. WO 2008/110531 discloses removal of residual solvent remaining after application of natamycin on the surface of a baked product using heat. Unfortunately, the resulting products are unattractive due to the presence of a white to off-white haze occurring post treatment. Hence, there is still a need to improve prevention of spoilage of baked products.

Following the above approaches for depositing natamycin, the natamycin often is not evenly distributed on the surface of the baked product. This problem is addressed in WO 2006/079646 by increasing the viscosity of the natamycin suspension by addition of a thickener before it is sprayed onto the baked product. In WO 2012/101256, cyclodextrin is used to form a complex with natamycin attempting to improve the distribution of natamycin on the surface of the baked product. However, problems associated with this approach are that cyclodextrin is relatively expensive and that the complexation may prevent adequate release of the active form of the antifungal.

Moreover, a major disadvantage of the prior art methods for application of natamycin on the surface of a baked product is that the resulting product is less attractive from a consumer perspective. Baked products treated with natamycin from commercially readily available suspensions, as used in the prior art methods, display after evaporation of the solvent a white to off-white haze on the outer surface of the baked product.

This unwanted phenomenon has hitherto not been addressed and consequently there remains a need for improving the use of natamycin in the preservation of baked products.

### DETAILED DESCRIPTION OF THE INVENTION

The present invention provides an improvement over the prior art of spraying natamycin on baked products. It provides a method wherein the resulting baked product displays less or no white haze compared to the product before treatment with natamycin. Additionally, the invention reduces other problems encountered in the prior art, such as clogging of spraying nozzles and the need for constant agitation of natamycin suspensions, during application of the aqueous solution comprising natamycin.

The present invention seeks to overcome the problems of the prior art, as described above, by providing a liquid solution of natamycin in combination with a metal salt of a carboxylic acid and applying that solution on a baked product. The solution is stable and comprises natamycin at high concentrations. In WO 98/48649 discloses the combination of natamycin and potassium sorbate for use in beverages but neither use for improving the shelf life of a baked product, nor highly concentrated natamycin solutions are suggested.

Throughout the present specification and the accompanying claims, the words “comprise”, “include” and “having” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article.

In the context of the invention the term “solution” refers to a composition in which one component (or mixture of components) is dissolved in another component (or mixture of components). When the one component (or mixture of components) is not (fully), i.e. partially, dissolved in another component (or mixture of components), the composition is referred to as a “suspension”. For example, a composition comprising 999.98 g of water and 0.02 g of natamycin (i.e. 20 ppm) wherein the natamycin is fully dissolved is referred to as a (20 ppm) solution of natamycin in water, whereas a composition comprising 999.8 g of water and 0.2 g of natamycin (i.e. 200 ppm) wherein the natamycin is partially dissolved is referred to as a (200 ppm) suspension of natamycin in water. In other words, in the context of the invention a solution does not comprise undissolved particles, or any undissolved particles do not, on a w/w basis, constitute more than 0.01% of the solution.

In a first aspect, the invention provides a process for improving the shelf life of a baked product, comprising contacting the baked product with a solution comprising natamycin and a metal salt of a carboxylic acid and water, wherein the amount of said natamycin is from 0.1 g/kg to 25 g/kg of the total weight of said solution and wherein the concentration of said metal salt of a carboxylic acid is from 0.01 mol/L to 5 mol/L. The latter concentrations refer to concentrations relative to the total solution comprising natamycin, metal salt of a carboxylic acid, water and other constituents.

Shelf life of a baked product can be established in various ways. In one embodiment, the time it takes for the visual occurrence of molds after a baked product is produced may be recorded. Also, the intensity of mold formation as a function of time may be recorded. For example, when freshly baked soft buns are left untreated in closed bags, mold formation can be visually observed after 13 days. When such buns are sprayed with water, mold formation can be observed even earlier, i.e. after 11 days. Visual mold formation usually begins with a single mold spot and quickly develops into severe mold coverage. Untreated soft buns usually display severe mold coverage after 20 to 25 days of storage. Improvement of the shelf life of a baked product is extension of the time wherein mold formation can be observed. In the process of the instant invention, soft buns for example do not display any visual mold formation after 11 days, also not after 13 days, also not after 15 days, also not after 20 days and also not after 25 days of storage.

In an embodiment, contacting of the baked product is realized by spraying the outer surface of the baked product with the solution comprising natamycin to deposit an effective amount of natamycin thereon.

By applying relatively high concentrations of metal salt of a carboxylic acid, like from 0.01 mol/L to 5 mol/L or from 0.05 mol/L to 1 mol/L or from 0.1 mol/L to 0.5 mol/L, natamycin is dissolved at high concentrations like from 0.05 g/kg to 50 g/kg, or from 0.1 g/kg to 25 g/kg, or from 0.5 g/kg to 10 g/kg, or from 1 g/kg to 5 g/kg. Routinely, solutions wherein all natamycin is dissolved at 1±0.02 g/kg, 2±0.02 g/kg, 10±1 g/kg, 25±1 g/kg, 40±1 g/kg, or 50±1 g/kg are available under the conditions of the present invention. It is known that increased solubility of natamycin can be achieved using organic solvents like e.g. ethanol, methanol or dimethylsulfoxide. However, in the instant invention, the solution comprising natamycin does not contain such solvents, i.e. contains less than 1 g/kg of dimethylsulfoxide and less than 1 g/kg of ethanol and less than 1 g/kg of methanol. Using high concentrated aqueous solutions of a metal salt of a carboxylic acid, the amount of water in the solution comprising natamycin is from 500 g/kg to 990 g/kg, or from 600 g/kg to 950 g/kg, or from 700 g/kg to 900 g/kg. Surprisingly, the solutions of the present invention, obtained by dissolving natamycin together with metal salts of carboxylic acids in the concentration mentioned above, results, when applied on a baked product, in a product that does not display undesirable white haze after treatment.

In an embodiment the solution comprising natamycin is sprayed homogeneously on all outer surfaces of the baked product to effectively protect the product. In this respect, the term homogeneously refers to an amount of natamycin per unit of surface area of the baked product on a given part of the outer surface of the baked product that is not more than 1.5 times, and not less than 0.5 times, of the amount of natamycin per unit of surface area of the baked product on any other outer part of the surface of the baked product. The shelf life of the baked product is further improved if the amount of natamycin per unit of surface area of the baked product on a given part of the outer surface of the baked product is not more than 1.25 times, and not less than 0.25 times, of the amount of natamycin per unit of surface area of the baked product on any other outer part of the surface of the baked product.

The solution comprising natamycin may be sprayed by a spinning disc, pneumatically operated spray gun or any other suitable spraying system capable of delivering a small but consistent and accurate spray volume over a given surface area such as an electrical paint spraying device. By way of non-limiting example, commercial paint spray guns from e.g. Energer, Erbauer, VonHause or Wagner and the like are suitable. The volume of the solution comprising natamycin sprayed onto the product should preferably be kept to the minimum level that will allow an even surface coverage.

In another embodiment, the solutions of the instant invention are obtained by dilution of a more concentrated solution with water. Advantageously, higher concentrated solutions may be prepared according to the instant invention, which is an advantage in view of transportation logistics and costs. At the location intended for use, such concentrated solutions may be diluted to make them ready for use. Practically, the dilution with a diluting agent is from 1 part solution to 100 parts of diluting agent, or from 1 part solution to 20 parts of diluting agent, or from 1 part solution to 10 parts of diluting agent, or from 1 part solution to 5 parts of diluting agent. The diluting agent usually is water although the skilled person appreciates that under the circumstances the diluting agent may comprise additional components, e.g. acids, bases or salts and the like. Thus, the invention further provides a solution comprising natamycin and a metal salt of a carboxylic acid and water wherein the amount of said natamycin is from 1 g/kg to 100 g/kg of the total weight of said solution and wherein the concentration of said metal salt of a carboxylic acid is from 0.1 mol/L to 10 mol/L.

In an embodiment, the solution of the present invention further comprises a diol having a boiling point of between 125° C. and 300° C. wherein the amount of said diol is from 50 g/kg to 950 g/kg of the total weight of said solution. For example, the amount of said diol may be from 100 g/kg to 900 g/kg of the total weight of said solution, from 250 g/kg to 850 g/kg of the total weight of said solution or from 500 g/kg to 800 g/kg of the total weight of said solution. It was observed that addition of a diol to the solution of the invention resulted in further enhancement of the stability and or a further increase of solubility of natamycin. Suitable diols are diols having a boiling point of from 125° C. to 300° C., or having a boiling point of from 150° C. to 250° C. Examples are dipropylene glycol, ethylene glycol, polyethylene glycol, propylene glycol or mixtures thereof. Diols that are not suitable for human consumption, that are even toxic, such as diethylene glycol, are excluded from application in the instant invention.

In an embodiment, the solution of the invention has a pH at 20±2° C. of from 6.0 to 10, such as from 6.5 to 9.8, or from 7.0 to 9.6. At the latter pH values the solubility of natamycin in water normally is much lower, for example, at neutral pH values this is around 0.04 g/kg (40 ppm).

In an embodiment, the metal of the metal salt of a carboxylic acid is an alkali metal or an alkali earth metal, examples of which are calcium, lithium, magnesium, potassium, or sodium. Practically, good results are obtained when the metal is potassium or sodium.

In another embodiment, the carboxylic acid comprises from 1 to 7 carbon atoms. Examples are acetic acid, benzoic acid, citric acid, formic acid, lactic acid, propionic acid, sorbic acid but also mixtures thereof. Good examples are carboxylic acids with 3 carbon atoms such as lactic acid and propionic acid and carboxylic acids with 6 carbon atoms such as citric acid and sorbic acid. The carboxylic acid may be unsaturated with one or more double bonds. The double bounds may be cis or trans oriented. A good example is a carboxylic acid having two trans oriented double bonds such as sorbic acid. The carboxylic acid may contain hydroxyl groups, such as citric acid and lactic acid. The carboxylic acid may have a single carboxyl function, but also two, three or more.

In another embodiment, the ratio of metal salt of a carboxylic acid to natamycin is from 0.1 (w/w) to 20 (w/w), or from 0.2 (w/w) to 15 (w/w), or from 0.5 (w/w) to 10 (w/w), or from 1 (w/w) to 8 (w/w). The foregoing numbers refer to ratio between the weight of metal salt of a carboxylic acid to the weight of natamycin and do not relate to the weight of the composition. Alternatively, on a molar basis, the ratio of metal salt of a carboxylic acid to natamycin is from 0.5 (mole/mole) to 100 (mole/mole), or from 1 (mole/mole) to 75 (mole/mole), or from 2.5 (mole/mole) to 50 (mole/mole), or from 5 (mole/mole) to 45 (mole/mole).

The process of the instant invention provides a baked product the shelf life of which has been improved by the use of natamycin on the surface thereof. The baked products also include those that are intended for a long shelf life and having a moisture content which makes them susceptible to surface spoilage by molds and yeasts. Such baked products are intermediate or high moisture baked products having a water activity >0.80, or >0.85 or more, for example from 0.80 to 0.95, or from 0.80 to 0.90, or from 0.85 to 0.90. A moisture content of 0.80 to 0.85 is regarded as an intermediate moisture content, while a moisture content above 0.85 is regarded as a high moisture content. Typical examples of such baked products are cakes, muffins, pancakes, pastry, pizzas, sponge cakes, tortillas, waffles, and similar high-water activity baked products as well as similar part-baked fine bakery products. Pizzas comprise ready-made pizzas or pizza bases. Although various ways of determining water activity are known to the skilled person, for the purpose of the instant invention reference is made to ISO 21807.

The surface of the fine bakery product of the invention comprises an effective amount of natamycin which is sufficient to keep the product free of mould and yeast growth even though the product is packaged and stored for a time of 2 weeks or more. The effective amount of natamycin on the surface of the finished product is between 0.1 to 50 μg per cm², or from 0.2 to 25 μg per cm², and is sufficient for keeping the baked product mold free for 3 to 10 weeks, or 6 to 10 weeks, or even longer, when the product is stored at ambient temperature, which usually ranges between 15 and 30° C. and which more often is from 18 to 25° C.

By applying natamycin as a water-based solution sprayed directly onto the surface of a baked product after the baking process, natamycin is brought adequately and in a sufficient amount directly at the surface of the baked product where the fungal contamination occurs. Any problems of losses of natamycin during the baking process and availability on the surface have been overcome. The problem of haze formation as occurring through the application of prior art natamycin suspensions is overcome. The resulting baked product does not display a white haze, in some case at least significantly less, compared to the product before treatment with natamycin, e.g. they are visually indistinguishable.

Remarkably, the stability of natamycin in the solution of the invention is high and the concentration of natamycin remains at high values, also after prolonged periods of time. This effect is the most pronounced where the carboxylic acid is sorbic acid. Also, this effect is most pronounced when the metal is and alkali metal such as potassium. Accordingly, the solution of the invention unexpectedly does not require further auxiliary materials such as chelating agents like EDTA or antioxidants to warrant chemical stability described in the prior art.

In a second aspect, the invention provides a baked product comprising natamycin, a metal salt of a carboxylic acid, and a diol. In an embodiment, the surface of said baked product comprises natamycin ranging from 0.1 to 50 μg per cm², a metal salt of a carboxylic acid ranging from 0.5 to 200 μg per cm², and a diol ranging from 0.01 to 5 mg per cm². The amounts of natamycin or metal salt of a carboxylic acid or diol on the surface of a baked product may be determined by drawing a rectangle on the baked product, calculating the surface of the rectangle and cutting out the rectangle from the baked product including some of the below material to obtain an excision. The thickness of the below material is not a crucial parameter as the components to be measured are on the surface only. Hence, the surface may be from 1 mm to 5 cm, or from 5 mm to 2 cm. Also, the thickness need not be the same at all points below the surface of the rectangle. The excision is then mixed with a solvent in which the components dissolve and the solution so obtained is analyzed using analytical tools available to the skilled person for the presence of the components in question.

In an embodiment, the baked product may be packaged in a protective envelope after spraying. Such envelope is preferably made of a transparent material such as a plastic film or box to allow viewing of the product. The packaging material may comprise polyolefins such as polypropylene and/or polyethylene, polyethylene terephthalate and it copolymers, polystyrene, polyvinylchloride, cellulose, paper, board or aluminum foil. The packaging material preferably is a moisture proof material. The packaged baked product preferably is designed such that it is suitable to apply in a consumer-focused environment. For example, when the baked product is a bun, packaging may be carried out such that multiple buns are packaged in one package. For example, 2 to 12 buns may be packaged in one package. The most suitable number of buns in a single package is 2, 4, 6, 8 or 10.

Storage of the packaged baked product is at a temperature of from 1 to 40° C., or of from 10 to 30° C.

In a third aspect, the invention provides a baked product obtainable by the process of the first aspect of the invention. The natamycin deposited on the surface of the baked product should be chosen such that it is effective in keeping the baked product mould free when stored for two to three weeks, or even when stored for two to five weeks. In practice, the amount of natamycin deposited on the surface of the baked product may range from 0.1 to 50 μg per cm², or from 0.2 to 25 μg per cm², or from 0.5 to 10 μg per cm².

### EXAMPLES

### General

### Measurement of pH

pH measurements were carried out at 20±2° C., unless otherwise mentioned, using a Radiometer model PHM220 pH meter equipped with a PHC3085-8 Calomel Combined pH electrode (D=5 MM).

### Determination of Natamycin

Natamycin concentrations were determined using LC-MS as follows.
HPLC system: Waters iClass
Column: Waters Symmetry C18, 4.6×150 mm, 3.5 μm, Part No. WAT200632, Column no. 1483, Lot no. 0198313011
Column temperature: 25° C.
Eluent A: 50 mM ammonium acetate buffer pH 5.8 (with acetic acid)
Eluent B: Acetonitrile
Wash: 60% acetonitrile/40% water (v/v)
Injection volume: 10 μl
Injector temperature: 10° C. in darkness
Flow: 1 mL/min

| | | | |
|---|---|---|---|
| Gradient: | Time (min) | Eluent A (%) | Eluent B (%) |

| | | |
|---|---|---|
| 0.0 | 73.0 | 27.0 |
| 10.0 | 73.0 | 27.0 |
| 21.0 | 65.0 | 35.0 |
| 21.5 | 73.0 | 27.0 |
| 25.0 | 73.0 | 27.0 |

PDA-detector: Water Acquity Photodiode Array detector
PDA-detection wavelength: 200-500 nm

| | |
|---|---|
| Fluorescence detector: | Water Acquity Fluorescence detector |

| | |
|---|---|
| Excitation wavelength | 303 nm |
| Emission wavelength | 397 nm |

| | |
|---|---|
| MS-detector: | Waters Xevo TQD |
| Software: | MassLynx |

The reverse phase HPLC uses a UV detector to determine the residual concentration of natamycin at 303 nm. A set of standard dilutions containing subsequently increasing concentrations of natamycin in methanol was made and from these a calibration curve was obtained. The concentration of natamycin should not exceed a concentration of 88 mg/L. Generally, the dilutions contained 20 mg of sample and 3 mL of methanol.

### Preparation of Soft Buns

Soft buns were made according to the recipe in the below Table. After baking of the doughs, buns were cooled down to <60° C. in the baking room and were handled with gloves to avoid contamination.

| Constituent ^{(a)} | g | % ^{(b)} |
|---|---|---|
| Flour | 2000 | 100 |
| Water | 1180 | 59 |
| Salt | 32.0 | 1.6 |
| Fresh yeast | 100.0 | 5.0 |
| Brood Mix | 240.0 | 12.0 |

^{(a)} Flour brand Orchidee obtained from Meneba, the Netherlands Fresh yeast Koningsgist obtained from AB Mauri. Brood mix Kleinbroodpoeder INK. Calcium propionate containing buns were prepared by adding 8.0 g (0.40%) of calcium propionate to the dough mix described in the Table.
^{(b)} Weight percentage relative to the amount of flour.

### Example 1

### Preparation of High Concentrated Natamycin Solutions with Potassium Formate

A 3.5 M solution of potassium formate in water (15.17 g) was mixed with propylene glycol (80.32 g) and natamycin (1.059 g) and heated for 2.57 h until a final temperature of 105° C. A second batch was prepared by mixing a 3.5 M solution of potassium formate in water (15.07 g) with propylene glycol (80.5 g) and natamycin (1.032 g) and heating for 3.25 h until a final temperature of 105° C. Both batches were filtered over a 2 μm filter and combined to give a solution with a natamycin concentration of 1.08% (w/w). This resulted in a salt/natamycin ratio of 4.4 (w/w) or 35 (mole/mole). Samples of the mixtures were analyzed over time by HPLC for residual natamycin concentration. The shelf life test of the mixtures was done by storage at low temperatures (4-7° C.) and ambient temperatures (20-24° C.).

TABLE
Stability of natamycin solutions (% refers to natamycin concentration in % (w/w))
in a mixture of propylene glycol and aqueous potassium formate at 4-7° C.

| | | Residual natamycin (%) | | | | | | | | | | | | | | |
|---|---|---|---|---|---|---|---|---|---|---|---|---|---|---|---|---|
| | | Time (days) | | | | | | | | | | | | | | |
| pH | % | 0 | 1 | 4 | 10 | 14 | 15 | 18 | 23 | 25 | 32 | 35 | 42 | 53 | 60 | 80 |
| 9.8 | 1 | 96 | | 96 | 97 | | 88 | 92 | | 91 | | | 88 | 90 | 96 | 87 |
| 6.2^{(a)} | 1 | 80 | | | | 43 | | | 22 | | 12 | 7 | | | | |

^{(a)}Blank (water instead of potassium formate)

TABLE
Stability of natamycin solutions (% refers to natamycin concentration in % (w/w))
in a mixture of propylene glycol and aqueous potassium formate at 20-24° C.

| | | Residual natamycin (%) | | | | | | | | | | | | | |
|---|---|---|---|---|---|---|---|---|---|---|---|---|---|---|---|
| | | Time (days) | | | | | | | | | | | | | |
| pH | % | 0 | 5 | 7 | 9 | 12 | 14 | 18 | 20 | 25 | 27 | 32 | 35 | 43 | 74 |
| 9.8 | 1 | 92 | 95 | 95 | 92 | 87 | | 92 | 87 | | 86 | 82 | 83 | 80 | 69 |
| 6.3^{(a)} | 1 | 83 | 72 | 66 | | 55 | 52 | | | 31 | 25 | | | 18 | 6 |

^{(a)}Blank (water instead of potassium formate)

TABLE
Stability of natamycin solutions (% refers to natamycin concentration
in % (w/w)) in a mixture of propylene glycol and aqueous potassium
formate at 4-7° C. In entries marked *, the pH has been lowered
to the indicated value by the addition of formic acid.

| | | Residual natamycin (%) | | | | | | | | | |
|---|---|---|---|---|---|---|---|---|---|---|---|
| | | Time (days) | | | | | | | | | |
| pH | % | 0 | 1 | 5 | 7 | 14 | 16 | 23 | 25 | 43 | 45 |
| 9.5 | 1 | 111 | | 114 | | 114 | | 112 | | 108 | |
| 9.0* | 1 | 93 | | 97 | | 94 | | 93 | | 92 | |
| 8.8* | 1 | 94 | | 96 | | 94 | | 93 | | 86 | |
| 5.9* | 1 | 83 | | 66 | | 45 | | 21 | | 2 | |

### Example 2

### Preparation of High Concentrated Natamycin Solutions with Potassium Sorbate

A 3 M solution of potassium sorbate in water (3 g) was mixed with propylene glycol (16 g) and natamycin (0.2 g) and heated until a final temperature of 105° C. to give a solution with a natamycin concentration of 1% (w/w). This resulted in a salt/natamycin ratio of 6.8 (w/w) or 30 (mole/mole). Samples of the mixtures were analyzed over time by HPLC for residual natamycin concentration. The shelf life test of the mixtures was done by storage at low temperatures (4-7° C.) and ambient temperatures (20-24° C.). For 2, 3, 4 and 5% solutions 0.4, 0.6, 0.8 and 1.0 g of natamycin was used, respectively. This results in salt/natamycin ratios of 3.4 (w/w) or 15 (mole/mole), 2.3 (w/w) or 10 (mole/mole), 1.7 (w/w) or 7.5 (mole/mole) and 1.4 (w/w) or 6 (mole/mole), respectively.

TABLE
Stability of natamycin solutions (% = natamycin concentration
in % (w/w)) in a mixture of propylene glycol and aqueous potassium
sorbate at 4-7° C. Blank refers to water instead of potassium sorbate.

| | | | Residual natamycin (%) | | | | | | | | | | | | | | | | |
|---|---|---|---|---|---|---|---|---|---|---|---|---|---|---|---|---|---|---|---|
| | | | Time (days) | | | | | | | | | | | | | | | | |
| | pH | % | 0 | 1 | 2 | 4 | 8 | 10 | 14 | 15 | 18 | 21 | 23 | 25 | 28 | 42 | 53 | 56 | 60 |
| | 9.5 | 1 | 94 | 92 | 91 | 96 | 88 | 90 | 91 | 85 | 89 | | 90 | 91 | 85 | 81 | 78 | 82 | 75 |
| | 9.8 | 1 | 96 | | 91 | | 88 | | 91 | | | 91 | | | 85 | 88 | | 82 | |
| | 9.7 | 1 | 95 | 98 | | 100 | | 94 | | 90 | 92 | | | 90 | | 78 | | 73 | 80 |
| | 9.7 | 2 | 94 | 94 | | 88 | 87 | | 78 | | | 79 | | | 74 | 64 | | | |
| | 9.8 | 3 | 84 | 81 | | 74 | 77 | | 67 | | | 63 | | | 62 | 56 | | | |
| | 9.6 | 4 | 74 | | | 65 | 60 | | 56 | | | 57 | | | 56 | | | | |
| | 9.5 | 5 | 65 | 59 | | 60 | 72 | | 57 | | | 55 | | | 54 | | | | |
| Blank | 6.2 | 1 | 80 | | | | | | 43 | | | | 22 | | 12 | | 1 | | |

TABLE
Stability of natamycin solutions in a mixture of propylene glycol and aqueous
potassium sorbate at 20-24° C. Blank is absence of potassium sorbate.

| | | | Residual natamycin (%) | | | | | | | | | | | | |
|---|---|---|---|---|---|---|---|---|---|---|---|---|---|---|---|
| | | | Time (days) | | | | | | | | | | | | |
| | pH | % | 0 | 5 | 7 | 9 | 12 | 14 | 18 | 20 | 25 | 27 | 32 | 43 | 74 |
| | 9.8 | 1 | 94 | 95 | 98 | 96 | 90 | 93 | 94 | 89 | 91 | 86 | 82 | 80 | 59 |
| | 9.7 | 1 | 98 | 97 | 95 | 92 | 95 | 92 | 95 | 88 | 90 | 84 | 79 | 72 | 56 |
| Blank | 6.2 | 1 | 83 | 72 | 66 | | 55 | 52 | | | 31 | 25 | | | 6 |

### Example 3

### Preparation of High Concentrated Natamycin Solutions with Potassium Sorbate

A 3 M solution of potassium sorbate in water (3 g) was mixed with natamycin (0.2 g) and heated until a final temperature of 105° C. to give a solution with a natamycin concentration of 6% (w/w) This resulted in a salt/natamycin ratio of 6.8 (w/w) or 30 (mole/mole). To obtain a 1% solution, 33 mg of natamycin was used instead of 0.2 g and heating during dissolution was omitted, resulting in a salt/natamycin ratio of 45 (w/w) or 200 (mole/mole). Samples of the mixtures were analyzed over time by HPLC for residual natamycin concentration. The shelf life test of the mixtures was done by storage at low temperatures (4-7° C.) and ambient temperatures (20-24° C.).

TABLE
Stability of natamycin solutions (% = natamycin concentration
in % (w/w)) in aqueous potassium sorbate at 4-7° C.

| | | Residual natamycin (%) | | | | | | | |
|---|---|---|---|---|---|---|---|---|---|
| | | Time (days) | | | | | | | |
| pH | % | 0 | 5 | 6 | 12 | 31 | 42 | 49 | 69 |
| 9.7 | 6 | 103 | 103 | 99 | 100 | 92 | 92 | 88 | 80 |

TABLE
Stability of natamycin solutions (% = natamycin concentration
in % (w/w)) in aqueous potassium sorbate at 20-24° C.

| | | Residual natamycin (%) | | | | | | | | |
|---|---|---|---|---|---|---|---|---|---|---|
| | | Time (days) | | | | | | | | |
| pH | % | 0 | 2 | 6 | 8 | 15 | 20 | 23 | 34 | 65 |
| 9.6 | 6 | 105 | 104 | 98 | 98 | 97 | 95 | 93 | 81 | 73 |
| 9.9 | 1 | 104 | 101 | 97 | 94 | 88 | 79 | 80 | 62 | 45 |

### Example 4

### Preparation of High Concentrated Natamycin Solutions with Sodium Propionate

A 4 M solution of sodium propionate in water (3 g) was mixed with propylene glycol (16 g) and natamycin (0.2 g) and heated until a final temperature of 105° C. to give a solution with a natamycin concentration of 1% (w/w). This resulted in a salt/natamycin ratio of 5.8 (w/w) or 40 (mole/mole). Samples of the mixtures were analyzed over time by HPLC for residual natamycin concentration. The shelf life test of the mixtures was done by storage at low temperatures (4-7° C.).

TABLE
Stability of natamycin solutions (% = natamycin concentration
in % (w/w)) in a mixture of propylene glycol and aqueous sodium
propionate at 4-7° C. In entries marked *, the pH has been
lowered to the indicated value by the addition of propionic acid.

| | | | Residual natamycin (%) | | | | | | | | | |
|---|---|---|---|---|---|---|---|---|---|---|---|---|
| | | | Time (days) | | | | | | | | | |
| K/Na | pH | % | 0 | 1 | 5 | 7 | 14 | 16 | 23 | 25 | 43 | 45 |
| Na | 8.7 | 1 | 87 | 85 | | 87 | | 84 | | 73 | | 57 |
| Na | 8.1* | 1 | 75 | 92 | | 83 | | 69 | | 50 | | 32 |
| Na | 6.2* | 1 | 86 | 78 | | 58 | | 35 | | 15 | | 2 |

### Example 5

### Preparation of High Concentrated Natamycin Solutions with Sodium Acetate

A 4.4 M solution of sodium acetate or a 5 M solution of potassium acetate in water (3 g) was mixed with propylene glycol (16 g) and natamycin (0.2 g) and heated until a final temperature of 105° C. to give a solution with a natamycin concentration of 1% (w/w). This resulted in a salt/natamycin ratio of 5.4 (w/w) or 44 (mole/mole) for sodium and 7.4 (w/w) or 50 (mole/mole) for potassium. Samples of the mixtures were analyzed over time by HPLC for residual natamycin concentration. The shelf life test of the mixtures was done by storage at low temperatures (4-7° C.) and ambient temperatures (20-23° C.).

TABLE
Stability of natamycin solutions in a mixture
of propylene glycol and aqueous sodium acetate
at 4-7° C. Blank refers to absence of sodium.

| | | | Residual natamycin (%) | | | | | | | | | |
|---|---|---|---|---|---|---|---|---|---|---|---|---|
| | | | Time (days) | | | | | | | | | |
| K/Na | pH | % | 0 | 1 | 12 | 13 | 23 | 24 | 30 | 31 | 50 | 51 |
| Na | 8.2 | 1 | 98 | 94 | | 76 | | 74 | | 72 | | 58 |
| Blank | 6.2 | 1 | 80 | | 43 | | 22 | | 12 | 7 | 1 | |

TABLE
Stability of natamycin solutions in a mixture of propylene
glycol and aqueous potassium acetate at 20-23°
C. Blank refers to absence of potassium acetate.

| | | | Residual natamycin (%) | | | | | | | | | | | |
|---|---|---|---|---|---|---|---|---|---|---|---|---|---|---|
| | | | Time (days) | | | | | | | | | | | |
| K/Na | pH | % | 0 | 2 | 6 | 8 | 12 | 15 | 20 | 23 | 30 | 34 | 50 | 65 |
| K | 8.9 | 1 | 95 | 94 | 91 | 93 | | 88 | 81 | 80 | | 72 | | 58 |
| Blank | 6.2 | 1 | 80 | | | | 43 | | | 22 | 12 | 7 | 1 | |

### Example 6

### Preparation of High Concentrated Natamycin Solutions with Sodium Lactate

A 9.3 M solution of sodium lactate in water (3 g) was mixed with propylene glycol (16 g) and natamycin (0.2 g) and heated until a final temperature of 105° C. to give a solution with a natamycin concentration of 1% (w/w). This resulted in a salt/natamycin ratio of 18 (w/w) or 93 (mole/mole). Samples of the mixtures were analyzed over time by HPLC for residual natamycin concentration. The shelf life test of the mixtures was done by storage at low temperatures (4-7° C.).

TABLE
Stability of natamycin solutions (% = natamycin
concentration in % (w/w)) in a mixture of propylene
glycol and aqueous sodium lactate at 4-7° C.

| | | | Residual natamycin (%) | | | | | | | | |
|---|---|---|---|---|---|---|---|---|---|---|---|
| | | | Time (days) | | | | | | | | |
| K/Na | pH | % | 0 | 1 | 3 | 6 | 10 | 27 | 38 | 45 | 65 |
| Na | 7.8 | 1 | 89 | 88 | 84 | 81 | 84 | 71 | 63 | 62 | 45 |

### Example 7

### Prevention of Mold Formation on Buns Using Preservatives

Soft buns were prepared as described under General and sprayed according to the below Table and references thereto. Per variant 8 buns were treated and these were placed together in a plastic bag which was subsequently closed. Visual evaluation was carried out without opening bags.

| | | Spray | Time (days)^{(c)} | | | | | | Haze |
|---|---|---|---|---|---|---|---|---|---|
| Entry | Preservative^{(a)} | pressure^{(b)} | 8 | 11 | 13 | 15 | 20 | 25 | formation^{(d)} |
| 1 | Blank | N/A | — | — | 2 + | 2 + | 2 ++ | 8 ++ | — |
| 2 | Water spray | Normal | — | 6 + | 8 + | 8 ++ | 8 ++ | 8 +++ | — |
| 3 | DelvoCid #1 | Normal | — | 1 + | 1 + | 1 ++ | 1 ++ | 2 + | + |
| | | | | | | | | 4 ++ | |
| 4 | DelvoCid #1 | High | — | — | — | — | — | — | + |
| 5 | DelvoCid #2 | Normal | — | — | 1 + | 1 + | 1 + | 1 + | + |
| 6 | DelvoCid #2 | High | — | — | — | — | — | — | + |
| 7 | HS | Normal | — | — | — | — | — | — | — |
| 8 | HS | High | — | — | — | — | — | — | — |
| 9 | Calcium | N/A | — | — | — | — | — | — | — |
| | propionate | | | | | | | | |

^{(a)}DelvoCid refers to an aqueous suspension of natamycin in water (4%), commercially available from DSM Food Specialties B.V. in The Netherlands. Two different batches (#1 and #2) were tested. HS refers to natamycin solution in propylene glycol and aqueous potassium formate, as described in Example 1, and diluted with water to a final concentration of 0.1% (w/w) natamycin.
^{(b)}Normal spray pressure was achieved by applying a standard household squeeze-and-release device for spraying plants with water. High pressure spraying was achieved by applying a standard high-pressure paint-spraying device (Wagner W100, atomization power 65 W, spraying volume 0-110 mL/min, performance 5 m² in 12 min.
^{(c)}The number refers to the number of buns infected (in total 8 buns were tested per run), the number of “+'s” refers to the intensity of mold growth, ranging from “+” (referring to a single mold spot) to “+++” (referring to severe mold coverage).
^{(d)}Visual observation of the buns after 8 days.

For entries 2-8, per entry 8 buns were sprayed with either normal or high pressure spraying system both on top and bottom. Accordingly, the buns were placed on a tray, sprayed and then manually turned over using gloves after which the other sides were sprayed. Spraying was done by one person with the aim to be as accurate as possible in repeatedly applying the same amount of liquid per bun; in total each bun was sprayed with 2.0 g of liquid, evenly distributed per side.

For entries 1 and 9, per entry 8 buns were left un-sprayed; for entry 9 calcium propionate was added to the dough before baking (0.4% w/w relative to the amount of flour).

The results demonstrate that soft buns sprayed with a natamycin solution derived from a highly concentrated solution of natamycin in propylene glycol and potassium formate resulted in the absence of formation of molds, even after the latest measuring point, 25 days. The resulting buns did not show any haze formation. Spraying of buns with natamycin solutions as obtained according to Examples 2 to 6 resulted in similar results, also without formation of haze. Soft buns sprayed with prior art natamycin suspensions, i.e. DelvoCid, do perform better in terms of mold formation than untreated buns or wetted buns, but by no means as good as soft buns sprayed with a natamycin solution derived from a highly concentrated solution of natamycin in a metal salt of a carboxylic acid with or without a diol. Importantly, soft buns sprayed with prior art natamycin suspensions, i.e. DelvoCid, show white haze following the spraying process.

1. A process for improving shelf life of a baked product, comprising contacting the baked product with a solution comprising natamycin and a metal salt of a carboxylic acid and water, wherein the amount of said natamycin is from 0.1 g/kg to 25 g/kg of the total weight of said solution and wherein the concentration of said metal salt of a carboxylic acid is from 0.01 mol/L to 5 mol/L.

2. The process according to claim 1, wherein said contacting is spraying said baked product with said solution.

3. The process according to claim 2, wherein said spraying is carried out with an electrical paint spraying device.

4. The process according to claim 1, further comprising packing said baked product after contacting with said solution into a protective envelope and storing a thus obtained packaged product at a temperature from 10 to 30° C.

5. The process according to claim 1, wherein said solution further comprises a diol having a boiling point of between 125° C. and 300° C. wherein the amount of said diol is from 5 g/kg to 950 g/kg of the total weight of said solution.

6. The process according to claim 5, wherein said diol is dipropylene glycol, ethylene glycol, polyethylene glycol, propylene glycol or mixtures thereof.

7. The process according to claim 1, wherein said solution has a pH at 20±2° C. of from 6.0 to 10.

8. The process according to claim 1, wherein said metal is an alkali metal or an alkali earth metal.

9. The process according to claim 8, wherein said alkali metal is lithium, potassium or sodium and wherein said alkali earth metal is calcium or magnesium.

10. The process according to claim 1, wherein said carboxylic acid is acetic acid, benzoic acid, citric acid, formic acid, lactic acid, propionic acid, sorbic acid or mixtures thereof.

11. The process according to claim 1, wherein said solution contains less than 1 g/kg of dimethylsulfoxide, and/or less than 1 g/kg of ethanol and/or less than 1 g/kg of methanol.

12. The process according to claim 1, wherein said baked product is selected from the group consisting of bread, muffins, pancakes, pastry, pizzas, sponge cakes, tortillas, waffles, and the like baked or part-baked products.

13. The process according to claim 1, wherein the water activity of said baked product is between 0.8 and 0.95.

14. A baked product comprising natamycin, a metal salt of a carboxylic acid, and a diol, wherein the surface of said baked product comprises natamycin ranging from 0.1 to 50 μg per cm², a metal salt of a carboxylic acid ranging from 0.5 to 200 μg per cm², and a diol ranging from 0.01 to 5 mg per cm².

15. The baked product according to claim 14 which is packaged in a protective envelope.
